(19) United States
(12) Patent Application Publication
(10) Pub. No.: US 2023/0295916 A1
(43) Pub. Date: Sep. 21, 2023

(54) Mounting Clamp

(71) Applicant: ERICO International Corporation, Solon, OH (US)

(72) Inventor: Scott Ernest Anderson, Garrettsville, OH (US)

(21) Appl. No.: 18/186,433

(22) Filed: Mar. 20, 2023

Related U.S. Application Data
(60) Provisional application No. 63/321,278, filed on Mar. 18, 2022.

(51) Int. Cl. E04B 1/58

(52) U.S. Cl. CPC E04B 1/5831; E04B 2001/2415

(57) ABSTRACT

A mounting clamp for coupling a mechanical component to a mounting bracket. The mounting clamp can include a set of clamp sections, including a first clamp section and a second clamp section, hingedly coupled and movable between an open configuration and a closed configuration. The first clamp section can have a first set of clasps and a first arcuate portion extending from a first base. The second clamp section can have a second set of clasps and a second arcuate portion extending from a second base. In the closed configuration the first and second sets of clasps extend in a first direction and define an attachment portion for attaching the mounting clamp to the mounting bracket and the first and second arcuate portions extend in a second direction, different from the first direction and define a retention portion for retaining the mechanical component therein.

### CROSS-REFERENCE TO RELATED APPLICATIONS

This application claims priority under 35 U.S.C. 119 from U.S. Provisional Application No. 63/321,278, filed Mar. 18, 2022, titled “Mounting Clamp,” and is incorporated herein by reference in its entirety.

### BACKGROUND

In many applications, it may be useful to support mechanical equipment (e.g., plumbing pipes, boxes, fittings, and other components) between structural members (e.g., wall studs). For example, according to some construction standards, mechanical equipment may be required to be supported at particular heights above a floor or at particular distances from certain other structures or components.

### SUMMARY

Some embodiments of the invention provide a mounting clamp for coupling a mechanical component to a mounting bracket. The mounting clamp can include a set of clamp sections, including a first clamp section and a second clamp section, hingedly coupled and movable between an open configuration and a closed configuration. The first clamp section can have a first set of clasps, including a first clasp and a second clasp, and a first arcuate portion extending from a first base. The second clamp section can have a second set of clasps, including a third clasp and a fourth clasp, and a second arcuate portion extending from a second base. In the open configuration the first and second arcuate portions can be spaced apart and configured to receive a mechanical component therebetween. In the closed configuration the first, second, third, and fourth clasps extend from the respective first and second base in a first direction and define an attachment portion for attaching the mounting clamp to the mounting bracket and the first and second arcuate portions extend from the respective first and second bases in a second direction, different from the first direction and define a retention portion for retaining the mechanical component therein.

Some embodiments of the invention provide a mounting clamp for coupling a pipe to a mounting bracket. The mounting clamp can include an attachment portion including a set of clasps extending from a base in a first direction. The set of clasps can be configured to engage opposing sides of the mounting bracket to retain the mounting clamp thereon. An arcuate portion can extend from the base in a second direction. The arcuate portion can be configured to retain the pipe therein. A set of wings, including a first wing and a second wing, can extend opposingly outward from the base in a third direction and a fourth direction, respectively. The first and second wings can be configured to biasingly engage the mounting bracket retained by the set of opposing clasps.

Some embodiments provide a method of installing a mounting clamp on a mounting bracket. The method can include, with the mounting clamp in an open configuration, placing the mounting clamp in a closed configuration by urging a first clamp section with a first snap closure toward a second clamp section with a second snap closure and interconnecting the first and second snap closures. A first set of clasps, including a first clasp and a second clasp, extending from a first base of the first clamp section in a first direction and a second set of clasps, including a third clasp and a fourth clasp, extending from a second base of the second clamp section in the first direction can be urged over and into engagement with the mounting bracket. The method can further include contacting a first wing extending from the first base and a second wing extending from the second base with a front surface of the mounting bracket. Further, the mounting clamp can be centered on the front surface of the mounting bracket via contacting a first stabilizing leg extending from the first clasp and a third stabilizing leg from the third clasp with a top surface of the mounting bracket and a second stabilizing leg extending from the second clasp and a fourth stabilizing leg from the fourth clasp with a bottom surface of the mounting bracket, opposite the top surface.

### BRIEF DESCRIPTION OF THE DRAWINGS

The accompanying drawings, which are incorporated in and form a part of this specification, illustrate embodiments of the invention and, together with the description, serve to explain the principles of embodiments of the invention:

FIG. 1 is a front top left isometric view of a mounting clamp in an open configuration according to an embodiment of the invention;

FIG. 2 is a rear top right isometric view of the mounting clamp of FIG. 1 in the open configuration;

FIG. 3 is a front top left isometric view of the mounting clamp of FIG. 1 in a closed configuration;

FIG. 4 is a rear top right isometric view of the mounting clamp of FIG. 1 in the closed configuration;

FIG. 5 is a top plan view of the mounting clamp of FIG. 1 in the closed configuration;

FIG. 6 is a left side elevation view of the mounting clamp of FIG. 1 in the closed configuration;

FIG. 7 is a front top left isometric view of the mounting clamp of FIG. 1 in the closed configuration on a mounting bracket according to an embodiment of the invention;

FIG. 8 is a close-up top plan view of the mounting clamp in the closed configuration on the mounting bracket as shown in FIG. 7;

FIG. 9 is a close-up rear elevation view of the mounting clamp in the closed configuration on the mounting bracket as shown in FIG. 7;

FIG. 10 is a front top left isometric view of the mounting clamp in the closed configuration on the mounting bracket as shown of FIG. 7 retaining an elongate object therein according to an embodiment of the invention;

FIG. 11 is a front top left isometric view of a mounting clamp in an open configuration according to another embodiment of the invention;

FIG. 12 is a rear top right isometric view of the mounting clamp of FIG. 11 in the open configuration;

FIG. 13 is a front top left isometric view of the mounting clamp of FIG. 11 in a closed configuration;

FIG. 14 is a rear top right isometric view of the mounting clamp of FIG. 11 in the closed configuration;

FIG. 15 is a rear plan view of the mounting clamp of FIG. 11 in the closed configuration;

FIG. 16 is a left side elevation view of the mounting clamp of FIG. 11 in the closed configuration; and

FIG. 17 is a front top left isometric view of the mounting clamp of FIG. 11 in the closed configuration on a mounting bracket retaining an elongate object therein according to an embodiment of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

Also as used herein, unless otherwise specified or limited, directional terms are presented only with regard to the particular embodiment and perspective described. For example, reference to features or directions as “horizontal,” “vertical,” “front,” “rear,” “left,” “right,” “upper,” “lower,” and so on are generally made with reference to a particular figure or example and are not necessarily indicative of an absolute orientation or direction. However, relative directional terms for a particular embodiment may generally apply to alternative orientations of that embodiment. For example, “front” and “rear” directions or features (or “right” and “left” directions or features, and so on) may be generally understood to indicate relatively opposite directions or features for a particular embodiment, regardless of the absolute orientation of the embodiment (or relative orientation relative to environmental structures). “Lateral” and derivatives thereof generally indicate directions that are generally perpendicular to a vertical direction for a relevant reference frame.

Also as used herein, ordinal numbers are used for convenience of presentation only and are generally presented in an order that corresponds to the order in which particular features are introduced in the relevant discussion. Accordingly, for example, a “first” feature may not necessarily have any required structural or sequential relationship to a “second” feature, and so on. Further, similar features may be referred to in different portions of the discussion by different ordinal numbers. For example, a particular feature may be referred to in some discussion as a “first” feature, while a similar or substantially identical feature may be referred to in other discussion as a “third” feature, and so on.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

As noted above, in some contexts, it may be useful to secure mechanical components (e.g., pipes or other fluid conduits) to structural members (e.g., wall studs) of a structure. Embodiments of the invention can be useful for this purpose, and others. For example, embodiments of the invention can be used to secure a plumbing pipe, gas line, or other mechanical component on a mounting bracket at a configurable distance away from structural members (e.g., in a space between adjacent studs).

In some embodiments, a mounting clamp can include a first clamp section coupled to a second clamp section that are moveable between an open configuration and a closed configuration. In some embodiments, the first and second clamp sections can be hingedly attached. For example, the first and second clamp sections can be joined with a living hinge.

In some configurations, the mounting clamp can have a set of clasps configured to engage with a mounting bracket to attach the mounting clamp to the mounting bracket when the mounting clamp is in a closed configuration. In some embodiments, mounting clamp support features can be provided to aid in maintaining a secure attachment of the mounting clamp to the mounting bracket. For example, biasing arms or wings can extend from the mounting clamp to urge contact between the set of clasps and the mounting bracket.

In some embodiments, a neutral orientation of a set of biasing arms or wings, relative to a main body of a mounting clamp, can dispose the arms or wings to be deflected by a bracket once the clamp is installed so as to provide reaction force that secures the mounting clamp in place regardless of whether any particular one of the arms or wings engages a portion of the bracket with a first thickness or a portion of the bracket with a second thickness. For example, a mounting clamp according to some embodiments can include biasing wings or arms that can biasingly secure the mounting clamp to a mounting bracket whether the mounting clamp is installed to span a seam between telescopically nested telescoping members of the mounting bracket, or to be only on one particular side of the seam.

In some embodiments, the wings can include protrusions or nubs that extend therefrom and are configured to be received within holes in the mounting bracket. Placement of the nubs in the holes can maintain the placement of the mounting clamp on the mounting bracket.

Further, centering features can be provided to center the mounting clamp vertically within the mounting bracket when attached to both a male section or a female section of a telescoping mounting bracket. For example, biasing tabs (e.g., stabilizing legs) can extend from the mounting clamp to contact the top side and the bottom side of the mounting bracket to urge the mounting clamp into a centered position.

In some embodiments, a mounting clamp can retain an elongate object therein vertically with respect to the orientation of the mounting bracket (e.g., vertically with respect to gravity for a horizontally installed mounting bracket). In some embodiments, a mounting clamp can retain an elongate object horizontally with respect to the orientation of the mounting bracket (e.g., horizontally with respect to gravity for a horizontally installed mounting bracket).

In some conventional arrangements, a mounting clamp will be mounted to a mounting bracket with fasteners (e.g., screws). This not only adds extra pieces and extra work to mount the mounting clamp to the mounting bracket, but it also requires removal of the fasteners if the mounting location must be changed. Additionally, conventional arrangements are configured to accommodate only one size of pipe. Therefore, an installer is required to stock multiple sizes of mounting clamps for differently sized pipe. All of this makes stocking and installing these types of mounting clamps more cumbersome.

Some embodiments of the invention can address these issues, or others. For example, some embodiments of the invention are presented below in the context of mounting clamps for mechanical components, wherein the mounting clamps are mountable to a mounting bracket without the need for fasteners or tools. Further, additional features allow for easily moving the mounting clamp along the mounting bracket after installation and also accommodate more than one size of pipe. Generally, however, the principles disclosed herein can be used with any variety of mounting clamp, including electrical conduit and so on, and can be used to secure any variety of components in place.

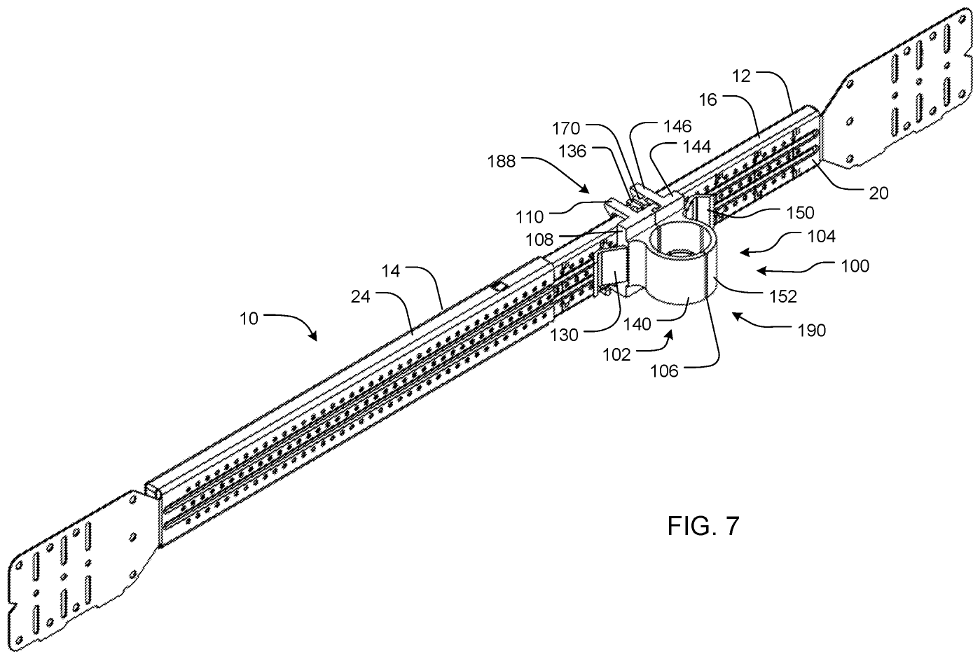

FIGS. 1 through 6 illustrate an embodiment of a mounting clamp 100 configured to be mounted to a mounting bracket (e.g., the telescoping mounting bracket 10 shown in FIG. 7 comprising a male bracket section 12 configured to laterally move within and relative to a female bracket section 14). The mounting clamp 100 has a set of clamp sections, including a first clamp section 102 and a second clamp section 104. The first and second clamp sections 102, 104 can be hingedly coupled, for example, by a living hinge 106. In such an embodiment, the first and second clamp sections 102, 104 comprise a unitary, one-piece, clamp. However, other configurations are contemplated, such as, for example, a snap closure to couple the first and second clamp sections 102, 104.

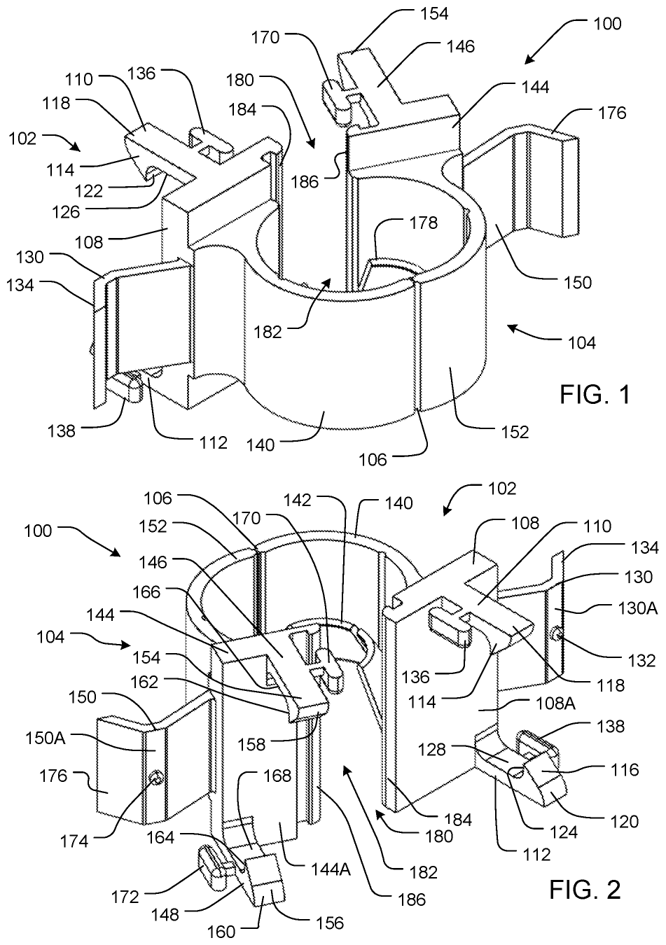

Continuing with the mounting clamp 100, the first clamp section 102 and the second clamp section 104 are formed as almost mirror images of each other. The first clamp section 102 has a first base 108 with a first base surface 108A. Extending from the first base 108 in a first direction outward and away from the first base surface 108A is a set of opposing clasps, including a first clasp 110 and a second clasp 112. As shown, the first clasp 110 and the second clasp 112 are spaced diagonally apart from each other along the first base 108 (i.e., spaced apart both horizontally and vertically as viewed in the orientation shown in FIG. 2). In other configurations, the first and second clasps 110, 112 can be directly opposed from each other (i.e., only spaced apart vertically).

The mounting clamp 100 includes features that allow it to engage with the mounting bracket 10. For example, each of the first and second clasps 110, 112 includes a barb 114, 116 at a distal end 118, 120 thereof. The barbs 114, 116 each have a contact surface 122, 124. The distance between each of the contact surfaces 122, 124 and the first base surface 108A defines a barb distance 40 (shown in FIG. 6). Further, each of the first and second clasps 110, 112 also has an inner surface 126, 128 extending therealong between the first base surface 108A and the barbs 114, 116, respectively. The inner surface 126 of the first clasp 110 and the inner surface 128 of the second clasp 112 are facing generally in the direction of the other, and the vertical spacing between the inner surfaces 126, 128 of the first and second clasps 110, 112 defines a clasp distance 50 as illustrated in FIG. 6. The first and second clasps 110, 112 are configured to extend over and contact opposing top and bottom sides of either the male bracket section 12 or the female bracket section 14. For example, as shown in FIGS. 7 through 9, the mounting clamp 100 is shown with the first clasp 110 extending over, with the inner surface 126 and the contact surface 122 contacting, a top side 16 of the male bracket section 12 and the second clasp 112 extending over, and the inner surface 128 and the contact surface 124 contacting, a bottom side 18 of the male bracket section 12.

The mounting clamp 100 can also include other features to further aid the engagement of the mounting clamp 100 to the mounting bracket 10. For example, a first wing 130 extends obliquely from the first base 108. The first wing 130 has a first wing surface 130A that is configured to contact a front surface of the mounting bracket 10 when the mounting clamp 100 is attached thereto. The horizontal spacing between the first wing surface 130A and the contact surfaces 122, 124 of the first and second clasps 110, 112 defines a wing distance 80 as illustrated in FIG. 6. With the first wing 130 in a neutral state as shown in FIG. 6, the wing distance 80 is less than the barb distance 40. Therefore, as shown in FIGS. 7 through 9, for example, the first wing surface 130A of the first wing 130 is in contact with a front surface 20 of the male bracket section 12 and is configured to urge the mounting clamp 100 away from the mounting bracket 10 in a direction opposite the first direction to enhance the engagement of the first and second clasps 110, 112 with mounting bracket 10. In some configurations, the barb distance 40 between the contact surface 122 of the barb and the first base surface 108A is equal to or slightly larger than the depth of the female bracket section 14, which is typically larger than the depth of the male bracket section 12. The first wing 130 can therefore make up for the differences in depth between the male bracket section 12 and the female bracket section 14 relative to the barb distance 40 to provide a secure attachment of the mounting clamp 100 to either the male or female bracket section 12, 14.

In some configurations, the first wing 130 can also include a locator nub 132 and a release tab 134. The locator nub 132 is located on and extends outward from the first wing surface 130A and is configured to be received within a hole in the mounting bracket 10. For example, looking at FIG. 9, the locator nub 132 of the first wing 130 is received within a hole 22 in the front surface 20 of the male bracket section 12 of the mounting bracket 10. Placement of the locator nub 132 within the hole 22 maintains the location of the mounting clamp 100 on the mounting bracket 10 and prevents the mounting clamp 100 from sliding transverse to the first direction along the mounting bracket 10. The release tab 134 extends obliquely from the first wing surface 130A and in a direction away from the first direction. With the locator nub 132 positioned within the hole 22, the release tab 134 is configured to be contacted and urged away from the mounting bracket 10, thereby moving the first wing 130 away from the mounting bracket 10 and the locator nub 132 out of the hole 22 to allow movement of the mounting clamp 100 transverse to the first direction along the mounting bracket 10.

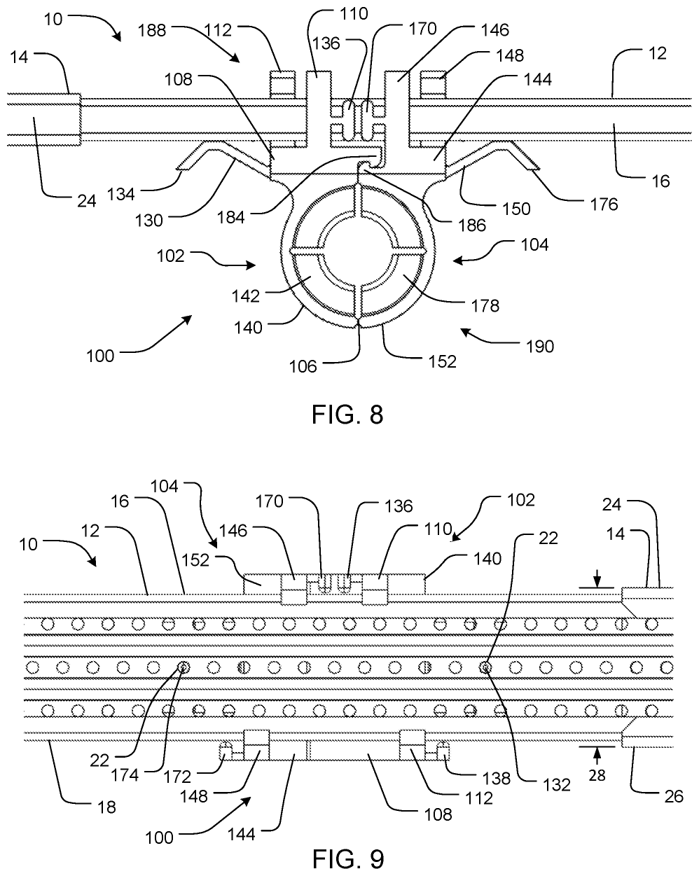

Additionally, other features can aid in centering, or aligning, the mounting clamp 100 vertically on the mounting clamp 100, as viewed, for example, in the orientation shown in FIG. 9. Each of the first and second clasps 110, 112 has stabilizing legs 136, 138 extending perpendicularly therefrom and spaced between the first base 108 and the barb 114 along the barb distance 40. The stabilizing legs 136, 138 can be cantilevered, elongate, resiliently flexible bodies with an enlarged free end. For example, as shown in FIGS. 1 through 5, the stabilizing legs 136, 138 are generally T-shaped, with the stem of the T-shaped stabilizing legs 136, 138 attached to the respective first and second clasps 110, 112 and the bar of the T-shaped stabilizing legs 136, 138 distal thereto. In some embodiments, the stabilizing legs 136, 138 are configured to extend over the top and bottom sides of the mounting bracket 10. For example, in FIGS. 8 and 9, the stabilizing legs 136, 138 are shown extending over and along the top and bottom sides 16, 18 of the male bracket section 12, respectively. The shape of the stabilizing legs 136, 138 allows the stabilizing legs 136, 138 to make and maintain contact along the depth of the mounting bracket 10 on the top and bottom sides 16, 18 and also permits flexing to center the mounting clamp 100 on the mounting bracket 10 regardless of whether the mounting clamp 100 is located on the male bracket section 12 or the female bracket section 14 or straddling the transition between the male and female bracket sections 12, 14. A stabilizing leg distance 60 (shown in FIG. 6) is defined as, with the stabilizing legs 136, 138 in a neutral state as shown, the vertical distance between the portions of the stabilizing legs 136, 138 configured to contact the mounting bracket 10. The stabilizing leg distance 60 is preferably the same or less than the distance between the top and bottom sides 24, 26 of the female bracket section 14 (see FIG. 7) (i.e., the female bracket section height 28) and less than the clasp distance 50 to allow the stabilizing legs to biasingly engage with the mounting bracket 10 to stabilize and center the mounting clamp 100 thereon Additionally, or alternatively, in some embodiments, as shown in FIG. 2, the stabilizing legs 136, 138 can extend in opposite directions relative to each other from the respective first and second clasps 110, 112. However, it is contemplated that the stabilizing legs 136, 138 can extend in the same direction from the respective first and second clasps 110, 112.

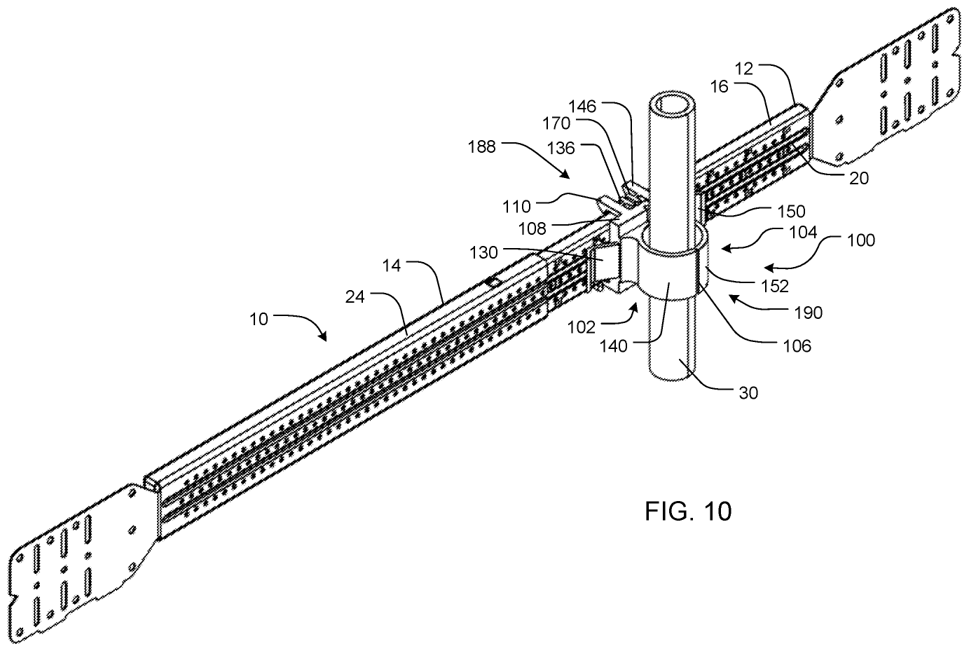

Continuing with the mounting clamp 100 shown in FIGS. 1 through 6, the first clamp section 102 also includes a first arcuate portion 140 extending from the first base 108 in a second direction, which is opposed to the first direction. The first arcuate portion 140 is sized and configured to receive an elongate object 30 therein, such as, for example, a rigid or flexible pipe as shown in FIG. 10. The first arcuate portion 140 also includes a set of fins 142 extending inwardly and obliquely from one end of the first arcuate portion 140. The set of fins 142 can be flexible and can be configured to conform to the elongate object 30 when it is received within the first arcuate portion 140. In some embodiments, the set of fins 142 can provide flexibility to allow one size of mounting clamp capable of accommodating more than one size of pipe (e.g., ½″ pipe and ¾″ pipe), because the set of fins 142 is pliable.

The second clamp section 104 is in many aspects similar to the first clamp section 102 described above and is almost an exact mirror image thereof. For example, the second clamp section 104 has a second base 144 with a second base surface 144A, third and fourth clasps 146, 148, a second wing 150 with a second wing surface 150A, and a second arcuate portion 152 all extending from the second base 144. Further, the third and fourth clasps 146, 148 each respectively have a distal end 154, 156; a barb 158, 160 with a contact surface 162, 164 at the distal end 154,156; an inner surface 166, 168; and a stabilizing leg 170, 172 extending therefrom. Additionally, the second wing 150 has a locator nub 174 and a release tab 176 and the second arcuate portion 152 has a set of fins 178.

Continuing, in FIGS. 1 and 2 the mounting clamp 100 is shown in an open configuration. The open configuration is such that the first and second clamp sections 102, 104 are coupled only at the living hinge 106 and movable relative to each other thereabout. Moving the first base 108 away from the second base 144 provides an opening 180. The opening 180 is configured to receive an elongate object (e.g., the elongate object 30 shown in FIG. 1) therethrough and into an attachment portion 188 defined by the first and second arcuate portions 140, 152.

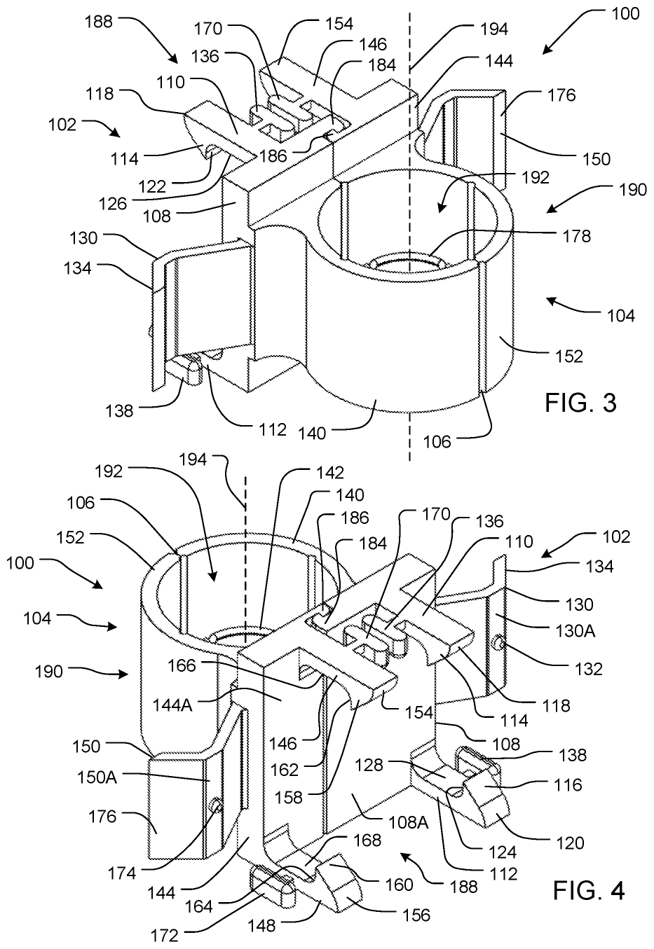

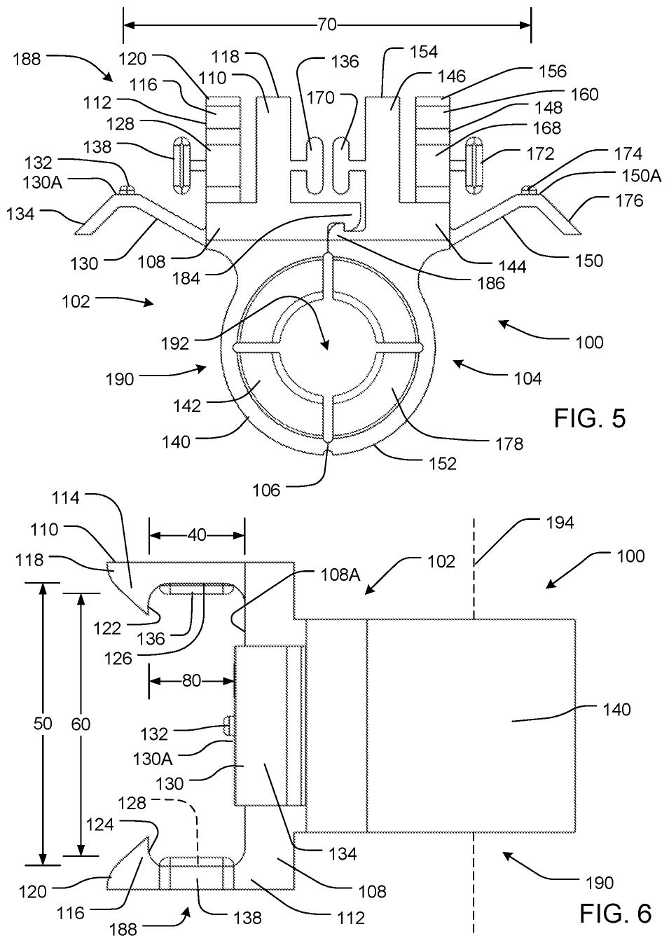

Further, FIGS. 3 and 4 illustrate the mounting clamp 100 in a closed configuration. First and second latches (here shown as first and second snap closures 184, 186) extend along adjacent facing sides of the first and second bases 108, 144, respectively. In the closed configuration, the first and second bases 108, 144 are moved toward each other, whereby the first and second snap closures 184, 186 interlock and maintain the engagement of the first and second clamp sections 102, 104 in the closed configuration. The closed configuration defines an attachment portion 188 that includes the first, second, third, and fourth clasps 110, 112, 146, 148 and the first and second bases 108, 144. The attachment portion 188 is configured to attach the mounting clamp 100 to a mounting bracket (e.g., the mounting bracket 10 shown in FIGS. 7 through 9). The closed configuration also defines a locator nub distance 70 (shown in FIG. 5) defined as the space between the centers of the locator nubs 132, 174 on the first and second wings 130, 150. The locator nub distance 70 is preferably dimensioned to allow both of the locator nubs 132, 174 to be received within respective holes in the mounting bracket, for example, as shown in FIG. 9, the locator nubs 132, 174 are received within respective holes 22 in the male bracket section 12.

Further, the closed configuration defines a retention portion 190 of the mounting clamp 100. The retention portion 190 includes the first and second arcuate portions 140, 152 and the respective fins 142, 178, which form a central passage 192 and defines a central passage axis 194. As shown in FIG. 4, the central passage axis 194 is oriented perpendicular to the first direction. The first direction being the direction in which the first and second clasps 110, 112 extend from the first base 108 as discussed above. As shown in FIG. 10, the mounting clamp 100 is configured to retain the elongate object 30 to the mounting bracket 10 in an orientation in which the elongate object 30 extends across the front surface 20 of the male bracket section 12 and perpendicular to a length of the mounting bracket 10 and the first direction.

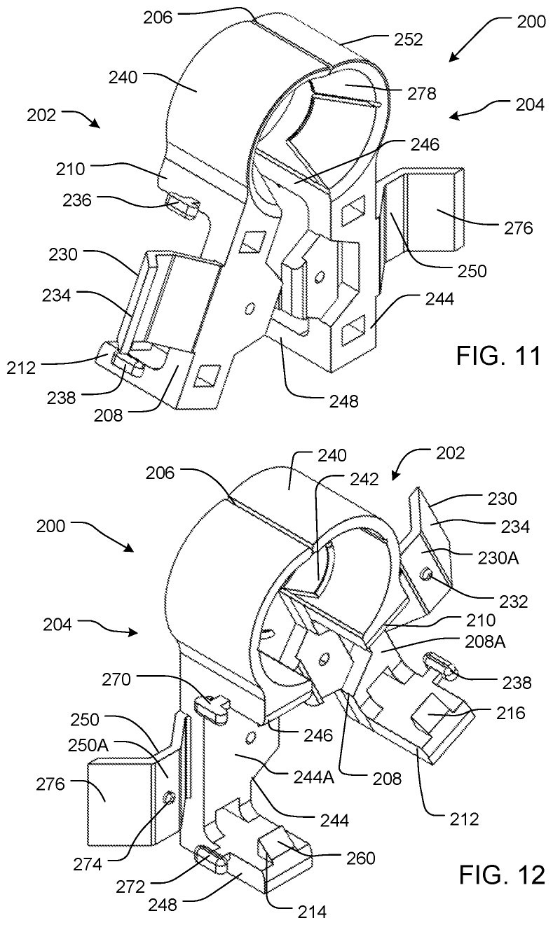

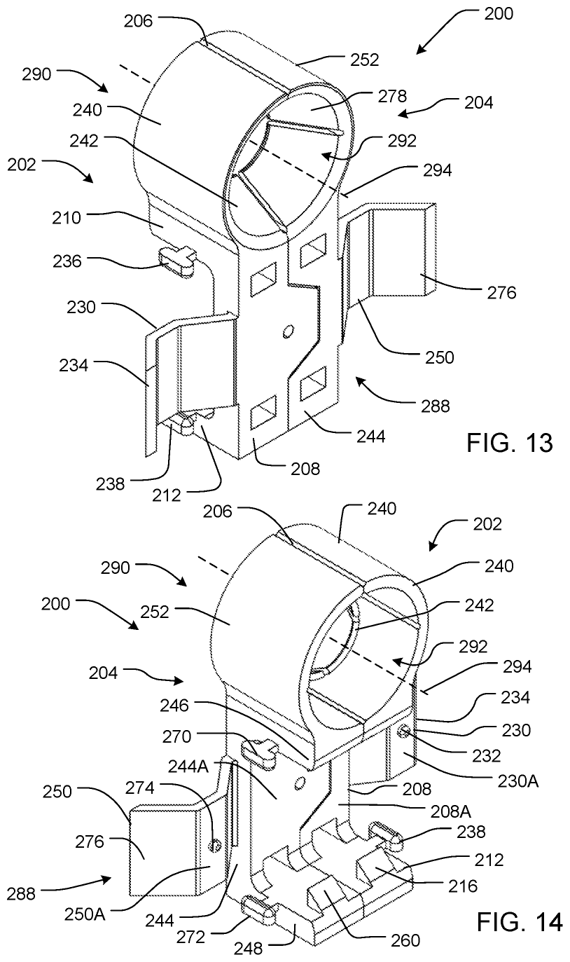

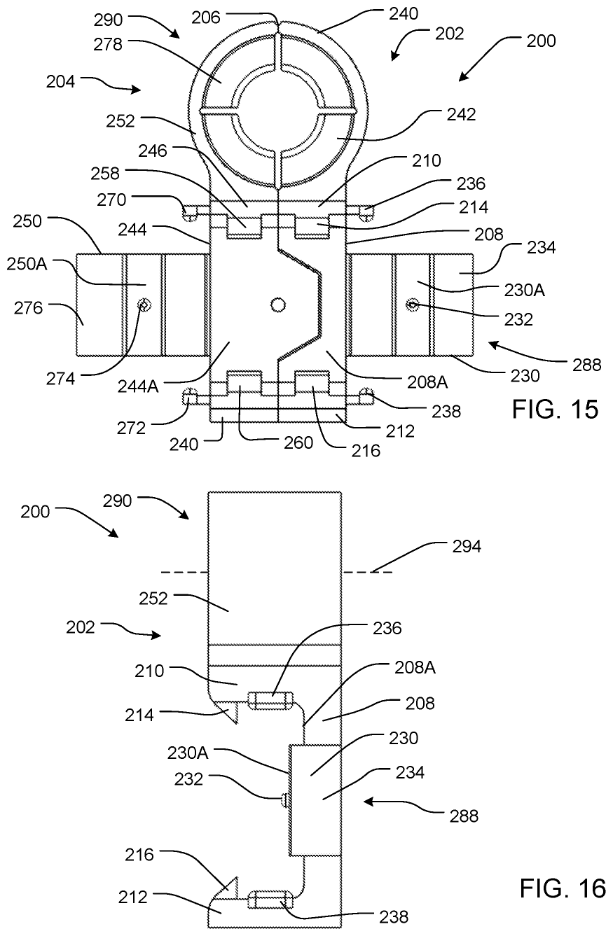

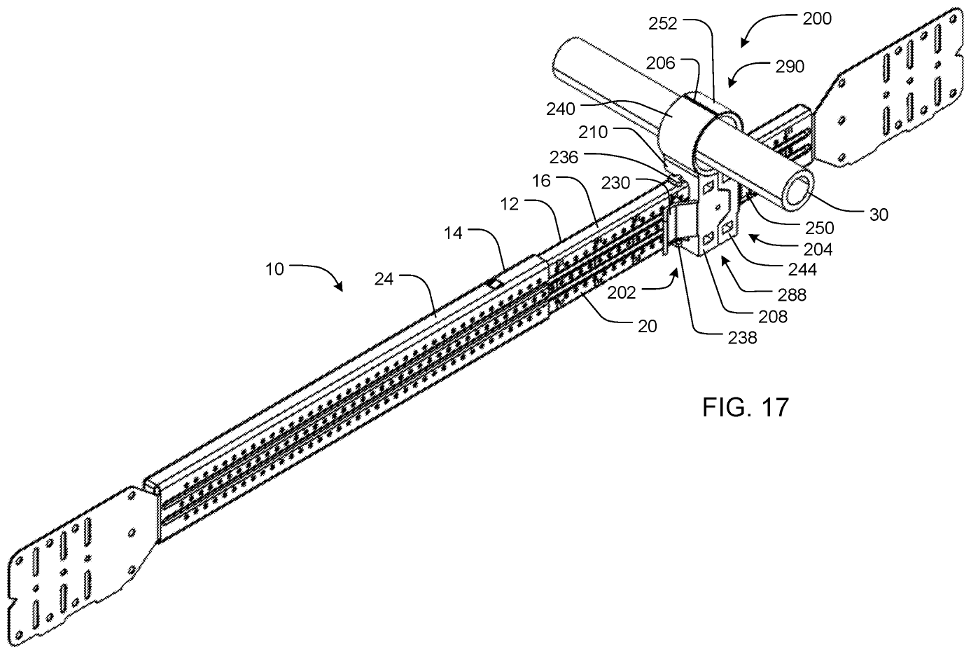

FIGS. 11-17 illustrate another embodiment of a mounting clamp 200 according to the invention, as also can be attached to a mounting bracket 10 (shown in FIG. 17). In many aspects, the mounting clamp 200 is similar to the mounting clamp 100 described above and similar numbering in the 200 series is used for the mounting clamp 100. For example, the mounting clamp 200 has first clamp section 202 with a first base 208, with a first base surface 208A; first and second clasps 210, 212 extending from the first base 208 in a first direction away from the first base surface 208A; and a first wing 230, with a first wing surface 230A, extending from the first base 208. The first and second clasps 210, 212 have barbs 214, 216, and the first wing 230 has a locator nub 232 extending from the first wing surface 230A and a release tab 234. The mounting clamp 200 also has a second clamp section 204 with a second base 244, with a second base surface 244A; third and fourth clasps 246, 248 extending from the second base 244 in the first direction away from the second base surface 244A; and a second wing 250, with a second wing surface 250A, extending from the second base 244. The third and fourth clasps 246, 248 have barbs 258, 260, and the second wing 250 has a locator nub 274 extending from the second wing surface 250A and a release tab 276. Additionally, each of the first, second, third, and fourth clasps 210, 212, 246, 248 has a stabilizing leg 236, 238, 270, 272 extending laterally outwardly therefrom, respectively. Further, the mounting clamp 200 has first and second arcuate portions 240, 252 with respective sets of fins 242, 278. Additionally, first and second clamp sections 202, 204 are moveable relative to each other about a living hinge 206 movable between an open configuration (shown in FIGS. 11 and 12) and a closed configuration (shown in FIGS. 13 and 14). Moreover, in the closed configuration, an attachment portion 288 and a retention portion 290 are defined. The retention portion 290 further defining a central passage 292 and a central passage axis 294. Additionally, the spatial relationships of the first and second bases 208, 244; the first, second, third, and fourth clasps 210, 212, 246, 248; the barbs 214, 216, 258, 260; the first and second wings 230, 250; and the stabilizing legs 236, 238, 270, 272 define distances in the mounting clamp 200 similar to the distances 40, 50, 60, 70 defined by the same features of the mounting clamp 100.

In some aspects, however, the mounting clamps 100, 200 differ from each other. For example, the first and second arcuate portions 240, 252 extend respectively from the first and third clasps 110, 146, in a second direction that is perpendicular to the first direction. Additionally, the central passage axis 294 is parallel to the first direction. As shown in FIG. 17, the mounting clamp 200 is configured to retain the elongate object 30 on the mounting bracket 10 in an orientation in which the elongate object 30 extends across the top side 16 of the male bracket section 12, perpendicular to the length of the mounting bracket 10 and parallel to the first direction.

In some implementations, devices or systems disclosed herein can be utilized or installed using methods embodying aspects of the invention. Correspondingly, description herein of particular features or capabilities of a device or system is generally intended to inherently include disclosure of a method of using such features for intended purposes and of implementing such capabilities. Similarly, express discussion of any method of using a particular device or system, unless otherwise indicated or limited, is intended to inherently include disclosure, as embodiments of the invention, of the utilized features and implemented capabilities of such device or system.

For example, with reference to FIGS. 1 through 9, some embodiments can include an installation method under which a user can install the mounting clamp 100 to a mounting bracket 10. The method can include, with the mounting clamp 100 in an open configuration (shown in FIGS. 1 and 2), receiving an elongate object (for example, the elongate object 30 shown in FIG. 10) within the first and second arcuate portions 140, 152. The mounting clamp 100 can be then be placed in a closed configuration (shown in FIGS. 3 and 4) by urging the first and second clamp sections 102, 104 toward each other and interconnecting the first and second snap closures 184, 186. The method can further include urging the first, second, third, and fourth clasps 110, 112, 146, 148 over and into engagement with a mounting bracket (for example, the mounting bracket 10 shown in FIG. 10). Some embodiments of the method can further include inserting locator nubs 132, 174 on first and second wings 130, 150 of the first and second clamp sections 102, 104 into respective holes 22 in the mounting bracket 10 to maintain the location of the mounting clamp 100 on the mounting bracket 10. Some embodiments of the method can include urging the first and second wings 130, 150 away from the mounting bracket 10 to disengage the locator nubs 132, 174 from the holes 22 to allow the mounting clamp 100 to translate along a length of the mounting bracket 10 transverse to the first direction (as defined above with respect to the first, second, third, and fourth clasps 110, 112, 146, 148). Some embodiments of the method can include retaining an elongate object 30 (e.g., a rigid or flexible pipe shown in FIG. 10) within a retention portion 190 defined by the first and second arcuate portions 140, 152 of the first and second clamp sections 102, 104. In some embodiments the elongate object 30 can be inserted through the retention portion 190 when the mounting clamp 100 is in the closed configuration (shown in FIGS. 3 and 4) before or after being attached to the mounting bracket 10. In some embodiments, the elongate object 30 can be inserted through a receiving space 182 between the first and second arcuate portions 140, 152 when the mounting clamp 100 is in the open configuration (shown in FIGS. 1 and 2) and then the mounting clamp 100 can be placed in the closed configuration (shown in FIGS. 3 and 4) to retain the elongate object 30 within the retention portion 190.

The previous description of the disclosed embodiments is provided to enable any person skilled in the art to make or use the invention. Various modifications to these embodiments will be readily apparent to those skilled in the art, and the generic principles defined herein may be applied to other embodiments without departing from the spirit or scope of the invention. Thus, the invention is not intended to be limited to the embodiments shown herein but is to be accorded the widest scope consistent with the principles and novel features disclosed herein.

What is claimed is:

1. A mounting clamp for coupling a mechanical component to a mounting bracket, the mounting clamp comprising:
a set of clamp sections, including a first clamp section and a second clamp section, hingedly coupled and movable between an open configuration and a closed configuration;
the first clamp section has a first set of clasps, including a first clasp and a second clasp, and a first arcuate portion extending from a first base and the second clamp section has a second set of clasps, including a third clasp and a fourth clasp, and a second arcuate portion extending from a second base;
in the open configuration the first and second arcuate portions are spaced apart and configured to receive a mechanical component therebetween;
in the closed configuration the first, second, third, and fourth clasps extend from the respective first and second base in a first direction and define an attachment portion for attaching the mounting clamp to the mounting bracket and the first and second arcuate portions extend from the respective first and second bases in a second direction, different from the first direction and define a retention portion for retaining the mechanical component therein.

2. The mounting clamp of claim 1, wherein the first clamp section includes a first wing extending from the first base and the second clamp section includes a second wing extending from the second base;
wherein, with the mounting clamp attached to the mounting bracket, the first and second wings contact the mounting bracket and urge the mounting clamp in a direction opposite the first direction, away from the mounting bracket to enhance the engagement of the first and second sets of clasps with the mounting bracket.

3. The mounting clamp of claim 2, wherein the first base has a first base surface and the first wing extends obliquely from the first base toward the first direction and has a first wing surface, the first wing surface positioned further than the first base surface along the first direction and configured to contact the mounting bracket.

4. The mounting clamp of claim 3, wherein the first wing has a locator nub receivable within a respective hole in the mounting bracket to prevent the mounting clamp from translating along the mounting bracket transverse to the first direction.

5. The mounting clamp of claim 4, wherein the first wing has a release tab operable to remove the locator nub from the respective hole in the mounting bracket to allow movement of the mounting clamp along the mounting bracket transverse to the first direction.

6. The mounting clamp of claim 5, wherein the release tab extends obliquely away from the first wing surface and the first direction.

7. The mounting clamp of claim 1, wherein the first clasp includes a first stabilizing leg extending laterally therefrom and the second clasp includes a second stabilizing leg extending laterally therefrom;
wherein, with the mounting clamp attached to the mounting bracket, the first and second stabilizing legs contact opposing sides of the mounting bracket to center the attachment portion thereon.

8. The mounting clamp of claim 7, wherein the first clasp has an inner surface facing an inner surface of the second clasp, the inner surfaces separated by a clasp distance extending vertically therebetween, and the first and second stabilizing legs are separated by a stabilizing leg distance extending vertically between the first and second stabilizing legs;
wherein the stabilizing leg distance is shorter than the clasp distance.

9. The mounting clamp of claim 1, wherein the first and second arcuate portions further include flexible fins extending therefrom and, with the mounting clamp in the closed configuration, the flexible fins are disposed inward toward each other and are configured to provide a biased engagement of a mechanical component received within the retention portion.

10. The mounting clamp of claim 1, wherein the retention portion defines a passageway therethrough extending along a retention portion axis;
wherein the retention portion axis is perpendicular to the first direction.

11. The mounting clamp of claim 1, wherein the retention portion defines a through-pas sage extending along a retention portion axis;
wherein the retention portion axis is parallel to the first direction.

12. A mounting clamp for coupling a pipe to a mounting bracket, the mounting clamp comprising:
an attachment portion including a set of clasps extending from a base in a first direction, the set of clasps configured to engage opposing sides of the mounting bracket to retain the mounting clamp thereon;
an arcuate portion extending from the base in a second direction, the arcuate portion configured to retain the pipe therein;
a set of wings, including a first wing and a second wing, extending opposingly outward from the base in a third direction and a fourth direction, respectively, the first and second wings configured to biasingly engage the mounting bracket retained by the set of opposing clasps.

13. The mounting clamp of claim 12, wherein the attachment portion includes a first clamp section hingedly attached to a second clamp section and configured to be movable between an open configuration and a closed configuration.

14. The mounting clamp of claim 13, wherein the first and second clamps are coupled via a living hinge.

15. The mounting clamp of claim 11, further comprising a set of stabilizing legs extending from the set of clasps configured to biasingly center the mounting clamp on the mounting bracket.

16. The mounting clamp of claim 11, further comprising a locating nub extending from at least one of the first or second wing configured to engage with the mounting bracket and prevent the mounting clamp from translating along the mounting bracket in the third or fourth directions.

17. A method of installing a mounting clamp on a mounting bracket, the method comprising:
with the mounting clamp in an open configuration, placing the mounting clamp in a closed configuration by urging a first clamp section with a first snap closure toward a second clamp section with a second snap closure and interconnecting the first and second snap closures;
urging a first set of clasps, including a first clasp and a second clasp, extending from a first base of the first clamp section in a first direction and a second set of clasps, including a third clasp and a fourth clasp, extending from a second base of the second clamp section in the first direction over and into engagement with the mounting bracket;
contacting a first wing extending from the first base and a second wing extending from the second base with a front surface of the mounting bracket; and
centering the mounting clamp on the front surface of the mounting bracket via contacting a first stabilizing leg extending from the first clasp and a third stabilizing leg from the third clasp with a top surface of the mounting bracket and a second stabilizing leg extending from the second clasp and a fourth stabilizing leg from the fourth clasp with a bottom surface of the mounting bracket, opposite the top surface.

18. The method of claim 17, further comprising:
inserting a locating nub extending from a first wing surface of the first wing into a hole in the front surface of the mounting bracket to maintain the location of the mounting clamp on the mounting bracket.

19. The method of claim 18, further comprising:
urging the first wing away from the mounting bracket to disengage the locating nub from the hole to allow the mounting clamp to translate along the mounting bracket transverse to the first direction.

20. The method of claim 19, wherein urging the first wing away from the mounting bracket includes contacting a release tab that extends obliquely away from the first wing surface and the first direction.
